(19) United States
(12) Patent Application Publication
(10) Pub. No.: US 2008/0137228 A1
(43) Pub. Date: Jun. 12, 2008

(54) MAGNETIC DISC DRIVE

(75) Inventors: Masanori Ueda, Kawasaki (JP); Haruyuki Matsunaga, Atsugi (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/034,418

(22) Filed: Feb. 20, 2008

Related U.S. Application Data
(63) Continuation of application No. PCT/JP2005/015796, filed on Aug. 30, 2005.

(51) Int. Cl. G11B 5/012; G11B 17/00

(52) U.S. Cl. 360/97.01

(57) ABSTRACT

A magnetic disc drive includes a head that is configured to record information in a recording medium or reproduce the information from the recording medium, a housing that houses the recording medium and the head, and a vibration damping mechanism that reduces a vibration of the housing, and includes a weight attached to the housing and a deformation reducer that reduces a deformation of the housing caused by the weight.

This application is a continuation of PCT International No. PCT/JP2005/015796, filed on Aug. 30, 2005, which is hereby incorporated by reference herein in its entirety as if fully set forth herein.

### BACKGROUND OF THE INVENTION

The present invention relates generally to a magnetic disc drive, and more particularly to a vibration damping mechanism. The present invention is suitable, for example, for a vibration damping mechanism used for a hard disc drive (“HDD”).

Along with the recent spread of the Internet etc. demands for providing inexpensive magnetic disc drives that can record a large amount of information including moving video pictures and still pictures have increased. A high recording-density disc drive needs high-accuracy head positioning performance. In addition, such a disc drive requires a housing that houses the discs with high, accuracy, and that reduces its vibrations and deformations. The environmental performance is also important, such as reductions of operational noises, and effective use of materials in manufacturing.

Aluminum die casting is usually used to form the housing precisely. In order to damp the noises and vibrations, prior art attaches weight (of a vibration damper) to the housing to attenuate the vibration energy.

Prior art include, for example, Japanese Patent Applications, Publication Nos. 9-320059, 7-252506, 2001-346924, and 2003-216141.

Since aluminum has a low specific gravity (2.7), use of a material having a high specific gravity for a vibration damping member is effective, such as an iron material (with a specific gravity of 7.9), a stainless steel material (with a specific gravity of 7.9), and a brass material (copper-zinc alloy with a specific gravity of 8.3). Among them, a material unit cost increases in order of an iron material, a stainless steel material, and a copper material, and thus the iron material and the stainless steel material are preferable in view of the cost. However, as shown in Table 1, the iron material and the stainless steel material have a large difference of a coefficient of thermal expansion from aluminum, causing the housing to thermally deform. It is thus preferable for performance purposes to use of the copper material (brass) that has a coefficient of thermal expansion similar to that of aluminum. On the other hands due to a limited mountable area of the vibration damper, the vibration damper requires profile accuracy, making manufacturing difficult. In particular, a thick metallic vibration damper requires stamping and/or machining process, and its manufacturing is difficult and expensive.

TABLE 1

| | | | A difference (μm) of a thermal |
|---|---|---|---|
| | | | expansion from aluminum |
| | | Coefficient of | on the assumption of a 70 |
| | | Thermal | mm-long weight (vibration |
| | Specific | Expansion | damper) and 80° C. |
| Material | Gravity | (×10⁻⁶/K) | rise in temperature |
| Aluminum | 2.68 | 21.0 | — |
| (ADC12) | | | |
| Iron Material | 7.85 | 11.7 | 52 |
| Stainless | 7.90 | 17.3 | 21 |
| Steel | | | |
| Brass | 8.46 | 18.4 | 15 |
| Zinc Alloy | 6.60 | 27.0 | 34 |

### BRIEF SUMMARY OF THE INVENTION

Accordingly, it is one illustrative object of the present invention to provide a magnetic disc drive having a vibration damping mechanism that can be easily and inexpensively manufactured.

A magnetic disc drive according to one aspect of the present invention includes a head that is configured to record information in a recording medium or reproduce the information from the recording medium, a housing that houses the recording medium and the head, and a vibration damping mechanism that reduces a vibration of the housing, and includes a weight attached to the housing and a deformation reducer that reduces a deformation of the housing caused by the weight This magnetic disc drive uses the weight as the vibration damping mechanism to reduce vibrations of the housing, and uses the deformation reducer of the vibration damping mechanism to reduce deformations of the housing. As a result, the high-accuracy head positioning on the recording medium (or disc) can be secured. In addition, the deformation reducer restrains deformations of the housing and reduces the manufacturing cost even when the weight is made of a material that has a substantial difference of a coefficient of thermal expansion from the housing's material.

The deformation reducer has some embodiments. For example, the deformation reducer may be a spacer part (such as an air gap or thermal insulator provided between the housing and the weight) that is located between the weight and the housing, and reduces a thermal contact area between the weight and the housing. The spacer part reduces a thermal contact area between the weight and the housing, and diminishes a deformation of the housing caused by a difference of a coefficient of thermal expansion between the weight and the housing. The deformation reducer may be a heat radiator (such as a convexo-concave fin provided on the surface of the weight) that enhances a heat radiation from the weight. This structure reduces dimensional change by heat of the weight through heat radiations, and thereby a deformation caused by the difference of a coefficient of thermal expansion. The deformation reducer may be elastic adhesive layer provided between the housing and the weight. The elastic adhesive layer absorbs a deformation of the weight, and can reduce the deformation of the housing.

The deformation reducer may be a cut part formed in the weight. This structure makes the weight flexible, and reduces its deformation that affects the deformation of the housing. The deformation reducer may be a fixture member that fixes the weight onto the housing at one spot. When the number of fixture members is one, no restraints prevent a deformation of the weight from affecting the housing, reducing a deformation of the housing.

A magnetic disc drive according to another aspect of the present invention includes a head that is configured to record information in a recording medium or reproduce the information from the recording medium, a housing that houses the recording medium and the head, and a vibration damping mechanism that reduces a vibration of the housing. The damping mechanism includes a weight attached to the housing, and the weight is made of at least one of resin, a sinter material, and a metal injection molding material containing metal additive. This weight can be made through injection molding, and its manufacture becomes easy and inexpensive.

A magnetic disc drive according to still another aspect of the present invention includes a head that is configured to record information in a recording medium or reproduce the information from the recording medium, a housing that houses the recording medium and the head, and a vibration damping mechanism that reduces a vibration of the housing. The damping mechanism includes a weight attached to the housing, and the weight is made through die casting or lost wax casting process that casts a high specific-gravity molten metal. This weight can be made through casting, and its manufacture becomes easy and inexpensive.

Other objects and further features of the present invention will become readily apparent from the following description of the preferred embodiments with reference to accompanying drawings.

### BRIEF DESCRIPTION OF THE DRAWINGS

FIG. 1 is a plane view of an internal structure of a HDD according to one embodiment of the present invention.

FIG. 2 is an enlarged perspective view of a magnetic head part in the HDD shown in FIG. 1.

FIGS. 3A to 3C are left side, plane and right side views respectively, showing a detailed structure of a head stack assembly shown in FIG. 1.

FIG. 4 is a schematic rear view of the HDD shown in FIG. 1.

FIG. 5 is a partially exploded perspective view of the HDD shown in FIG. 1 at the rear side.

FIG. 6 is a block diagram of a control system in the HDD shown in FIG. 1.

FIG. 7 is a schematic perspective view at the rear side of a three-dimensional weight applicable to the HDD shown in FIGS. 4 and 5.

FIG. 8 is a schematic partially sectional view of a first embodiment a vibration damping mechanism shown in FIGS. 4 and 5.

FIG. 9 is a schematic partially sectional view of a second embodiment a vibration damping mechanism shown in FIGS. 4 and 5.

FIG. 10 is a schematic partially sectional view of a third embodiment a vibration damping mechanism shown in FIGS. 4 and 5.

FIG. 11 is a schematic partially sectional view of a fourth embodiment a vibration damping mechanism shown in FIGS. 4 and 5.

FIG. 12 is a schematic partially sectional view of a fifth embodiment a vibration damping mechanism shown in FIGS. 4 and 5.

### DETAILED DESCRIPTION OF THE PREFERRED EMBODIMENTS

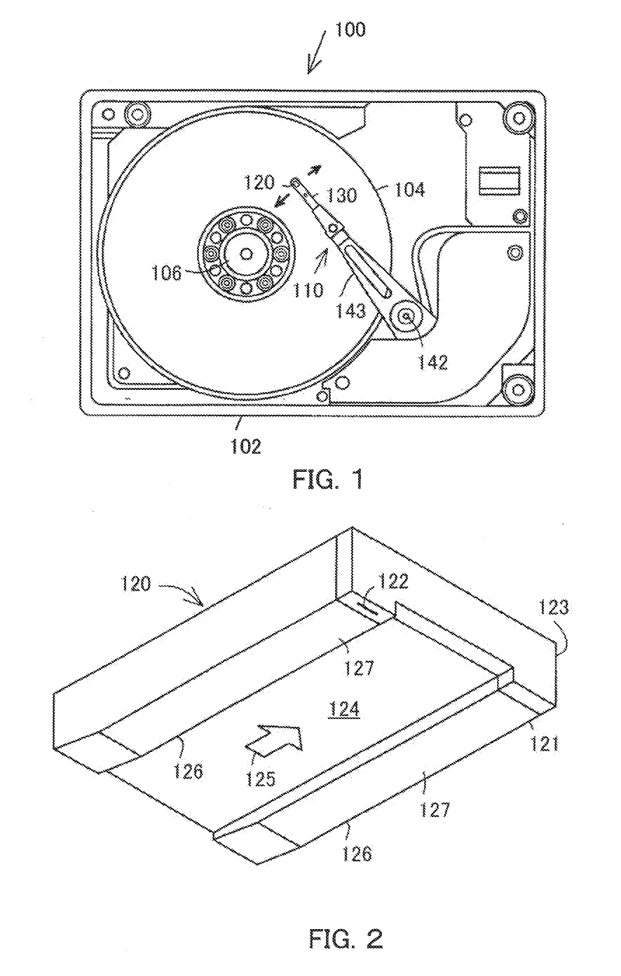

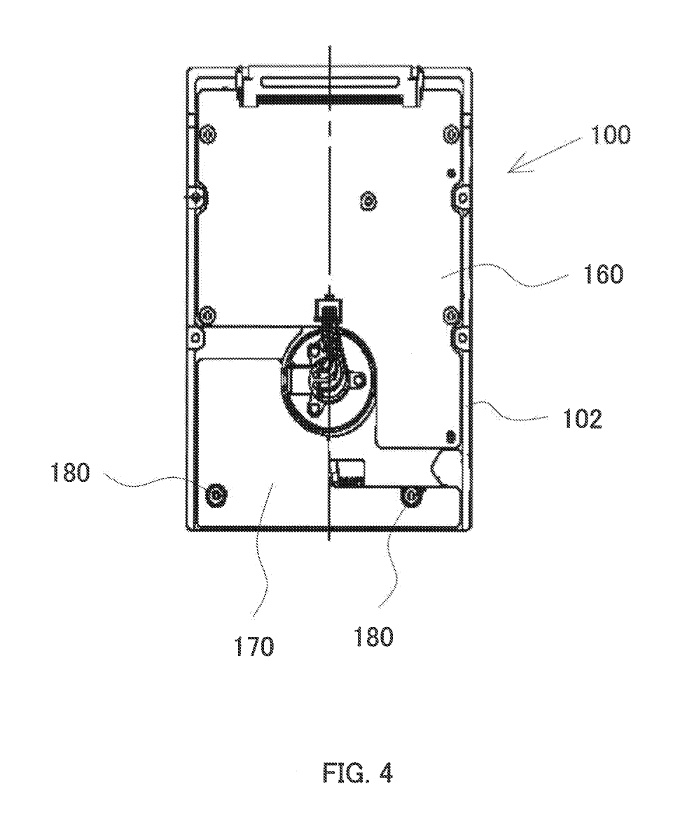

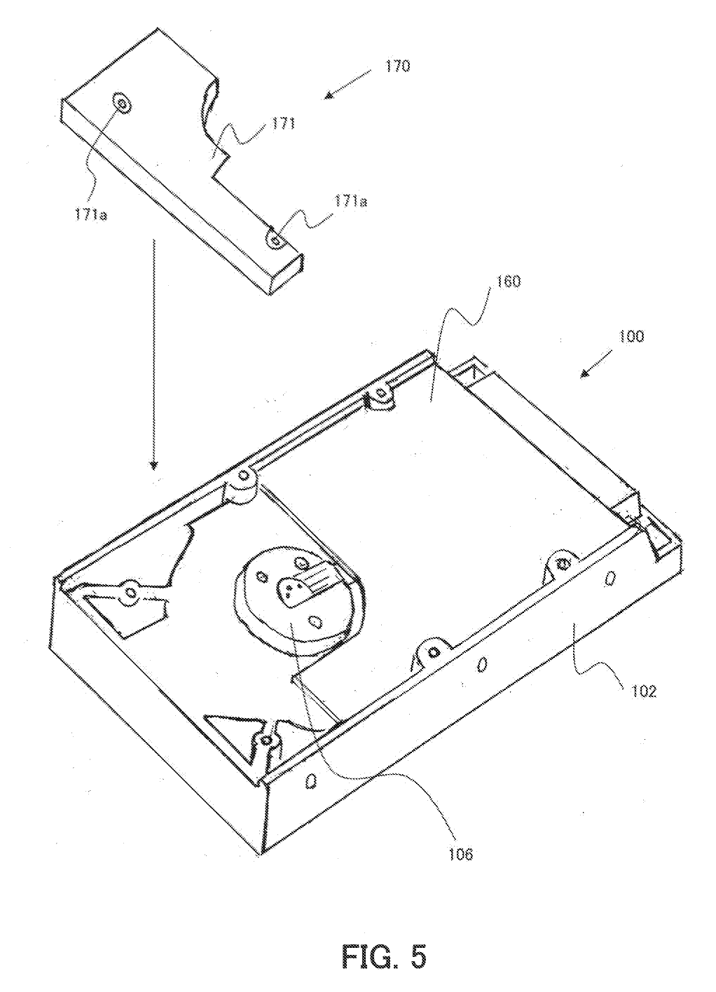

Referring now to the accompanying drawings, a description will be given of a HDD 100 according to one aspect of the present invention. The HDD 100 includes, as shown in FIG. 1, plural magnetic discs 104 each serving as a recording medium, a spindle motor 106, and a head stack assembly (“HSA”) 110, a printed circuit board 160 and a vibration damping mechanism 170 in a housing 102. Here, FIG. 1 is a schematic plane view of the internal structure of the HDD 100. The printed circuit board 160 and the vibration damping mechanism 170 are shown in FIGS. 4 and 5, FIG. 4 is a rear view of the HDD 100, and FIG. 5 is a partially exploded perspective view of the HDD 100 at the rear side.

The housing 102 is made, for example, of aluminum die-cast, and has a rectangular parallelepiped shape to which a cover (not shown) that seals the internal space is jointed. The magnetic disc 104 of this embodiment has a high surface recording density, such as 100 Gb/in² or greater. The magnetic disc 104 is mounted on a spindle of the spindle motor 106 through its center hole of the magnetic disc 104.

The spindle motor 106 rotates the magnetic disc 104 at such a high speed as 15,000 rpm, and has a brushless DC motor (not shown) and a spindle as its rotor part. For instance, two magnetic discs 104 are used in order of the disc, a spacer, the disc and a clamp stacked on the spindle, and fixed to the spindle by bolts.

The HSA 100 includes a magnetic head part 120, a suspension 130, a carriage 140, and a base plate 150.

The magnetic head 120 includes, as shown in FIG. 2, an approximately rectangular parallelepiped, Al₂O₃—TiC (Altic) slider 121, and a head device built-in film 123 that is jointed with an air outflow end of the slider 121 and has a reading and recording head 122. Here, FIG. 2 is an enlarged perspective view of the magnetic head part 120. The slider 121 and the head device built-in film 123 define a medium opposing surface to the magnetic disc 104, i.e., a floating surface 124, which receives airflow 125 that occurs with rotations of the magnetic disc 104.

A pair of rails 126 extends from the air inflow end to the air outflow end on the floating, surface 124. A top surface of each rail 126 defines a so-called air-bearing surface (“ABS”) 127. The ABS 127 generates a floating force in cooperation with actions of the airflow 125. The head 122 embedded into the head device built-in film 123 exposes from the ABS 127. The floating system of the magnetic head part 120 is not limited to this mode, and may use known dynamic and static pressure lubricating systems, piezoelectric control systems, and other floating systems. The activation system may be a contact start stop (“CSS”) system in which the magnetic head part 120 contacts the disc 104 in a nonoperating state, or a dynamic or ramp loading system in which the magnetic head part 120 is out of contact with the disc 104 in a nonoperating state, lifted up from the disc 104 and held on a ramp that is located outside the disc 104, and the magnetic head part 120 is dropped from the holding part to the disc 104 at startup.

The head 122 is, for example, a MR inductive composite head that includes an inductive head device that writes binary information on the magnetic disc 104 utilizing the magnetic field generated by a conductive coil pattern (not shown), and a magnetoresistive (“MR”) head that reads the binary information based on the resistance that varies in accordance with the magnetic field applied by the magnetic disc 104. A type of the MR head device may use a giant magnetoresistive (“GMR”), a CIP-GMR (“GMR”) that utilizes a current in plane (“CIP”), a CPP-GMR that utilizes a perpendicular to plane (“CPP”), a tunneling magnetoresistive (“TMR”), an anisotropic magnetoresistive (“AMR”), etc.

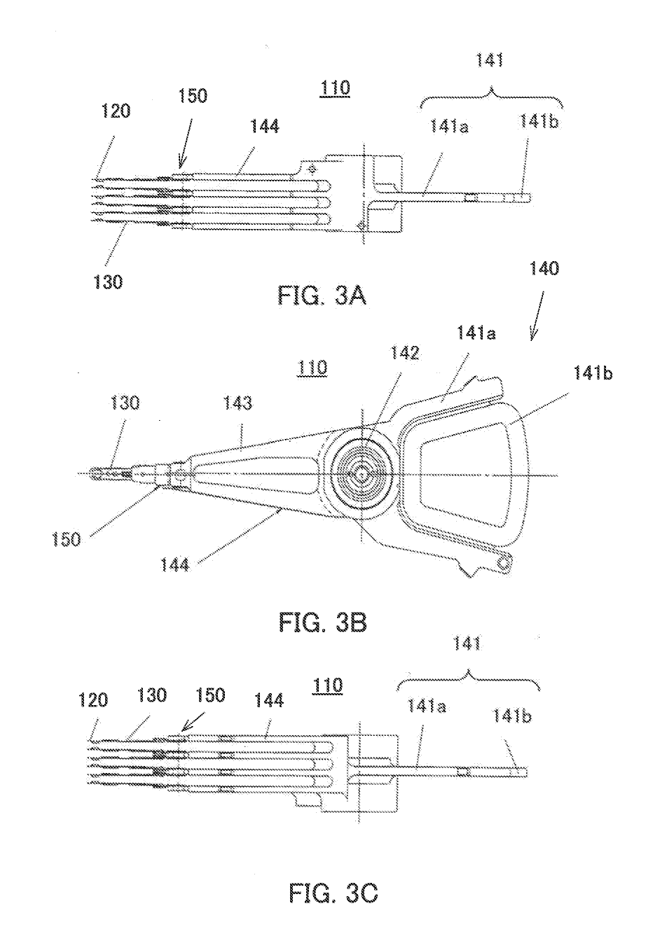

The suspension 130 serves to support the magnetic head part 120 and to apply an elastic force to the magnetic head part 120 against the magnetic disc 104, and is, for example, a stainless-steel Watlas type suspension. This type of suspension has a flexure (also referred to as a gimbal spring or another name) which cantilevers the magnetic head part 120, and a load beam (also referred to as a load arm or another name) which is connected to the base plate. The load beam has a spring part at its center so as to apply a sufficient bias force in a Z (height) direction. Thus, the load beam includes a rigid part at its proximal end, a spring part at its center, and a rigid part at its distal end. The load beam contacts the flexure via a projection called a dimple (referred to as a pivot or another name) so that the ABS 124 can follow the disc's warps and swells and always maintain a parallelism to the disc surface. The magnetic head part 120 is designed to softly pitch and roll around the dimple. The suspension 130 also supports a wiring part (not shown) that is connected to the magnetic head part 120 via a lead etc. Via this lead, the sense current flows and read/write information is transmitted between the head 122 and the wiring part. The wiring part is connected to a relay flexible circuit board (“FPC”) 143 under the arm 144 shown in FIG. 3B.

The carriage 140 is also referred to as an “actuator”, an “E-block” due to its E-shaped section or “actuator (“AC”) block.” The carriage 140 serves to swing the magnetic head part 120 in arrow directions shown in FIG. 1 and includes, as shown in FIGS. 1 and 3A to 3C, a voice coil motor 141, a shaft 142, a FPC 143, and all arm 144. FIG. 3A is a left side view of the HSA 110. FIG. 3B is a plane view of the HSA 110. FIG. 3C is a right side view of the HSA 110. While FIGS. 3A to 3C show the carriage 140 that drives six magnetic head parts 120 that record and reproduce both sides of three discs 104, the number of discs is, of course not limited to three.

The voice coil motor 141 has a flat coil 141b between a pair of coil holding arms 141a. The flat coil 141b opposes to a magnetic circuit (not shown) provided to the housing 102 of the HDD 100, and the carriage 140 swings around the shaft 142 in accordance with the current value that flows through the flat coil 141b. The magnetic circuit includes, for example, a permanent magnet fixed onto an iron yoke fixed in the housing 102. The shaft 142 is inserted into a cylindrical hole in the carriage 140, and extends perpendicular to the housing 102 in the plane view of FIG. 1. The FPC 143 provides the wiring part with a control signal, a signal to be recorded in the disc 104, and the power, and receives a signal reproduced from the disc 104.

The arm 144 is an aluminum rigid body that can swing around the shaft 142, and has a through hole at its top. The suspension 130 is attached to the arm 144 via the through hole in the arm 144 and the base plate 150. The arm 144 has a comb shape when viewed from a side as shown in FIGS. 3A and 3C.

The base plate 150 serves to attach the suspension 130 to the arm 144. One end of the base plate 150 is laser-welded onto the suspension 130, and the other end of the base plate 150 is swaged with the arm 144.

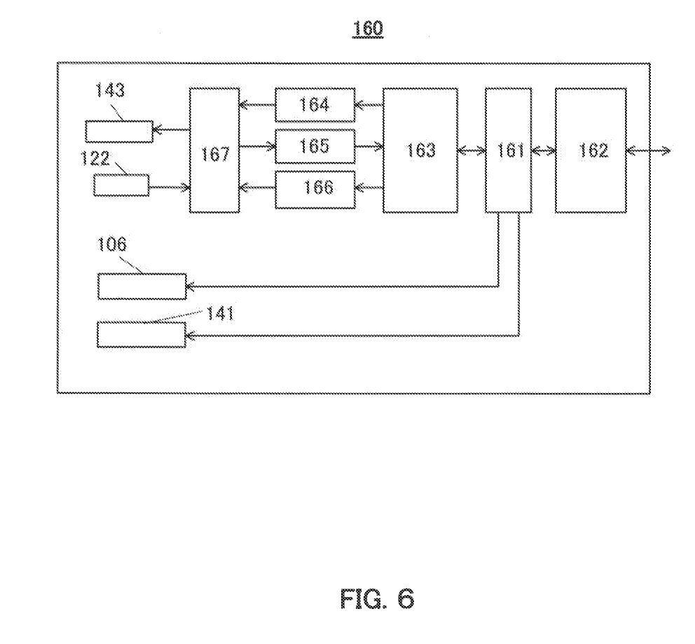

The printed circuit board 160 is fixed onto a bottom surface of the housing 102, as shown in FIGS. 4 and 5, and mounted with a control system shown in FIG. 6. FIG. 6 shows a control block diagram of the control system in the HD) 100 and illustrates the control system in which the head 122 has an inductive head and an MR head. The control system, which can be implemented as a control board in the HDD 100, includes a controller 161, an interface 162, a hard disc controller (referred to as “HDC”) hereinafter) 163, a write modulator 164, a read demodulator 165, a sense-current controller 166, and a head IC 167. Of course, they are not necessarily integrated into one unit; for example, only the head IC 167 may be connected to the carriage 140.

The controller 161 covers any processor such as a CPU and MPU irrespective of its name, and controls each part in the control system. The interface 162 connects the HDD 100 to an external apparatus, such as a personal computer (“PC” hereinafter) as a host. The HDC 163 sends to the controller 161 data that has been demodulated by the read demodulator 165, sends data to the write modulator 164, and sends to the sense-current controller 166 a current value as set by the controller 161. Although FIG. 6 shows that the controller 161 provides servo control over the spindle motor 106 and the voice coil motor in the carriage 140, the HDC 163 may serve as such servo control.

The write modulator 164 modulates and supplies the data to the head IC 167, which data has been supplied, for example, from the host through the interface 162 and is to be recorded onto the disc 104 by the inductive head. The read demodulator 165 demodulates data into an original signal by sampling data read from the disc 104 by the MR head device. The write modulator 164 and read demodulator 165 may be recognized as one integrated signal processing part. The head IC 167 serves as a preamplifier. Each part may apply any structure known in the art, and a detailed description thereof will be omitted.

The vibration damping mechanism 170 is provided on the bottom surface of the housing 120, as shown in FIGS. 4 and 5. The vibration damping mechanism 170 serves to reduce vibrations and noises of the housing 120. The vibrations and noises are caused (1) by the resonance of the entire HDD 100 as a result of that a rotation of the motor 106 that drives the disc 104 transmits to the housing 102; and (2) by the resonance of the entire HDD 100 when the housing 102 minutely vibrates due to reactions of seeking actions of the carriage 140 that drives the magnetic head part 120. The resonance of the entire HDD 100 results in the R residue vibration, and deteriorates the positioning accuracy of the head 122. Since the heavy weight of the housing 102 effectively attenuates the vibration energy of the housing 102 and shifts the resonance frequency, the vibration damping mechanism 170 is mounted as the weight 171 on the HDD 100 with screws 180.

The vibration damping mechanism 170 needs to be located outside the printed circuit board 160. Since a position of the printed circuit board 160 is previously determined for physical interfaces with various HDD built-in units, a physical interface with the FPC 143, and electrical noise reductions, a location of the vibration damping mechanism 170 is limited to an area in the housing's shape shown in FIG. 5 which does not interfere with the printed circuit board. Since the vibration damping mechanism 170 needs to be mounted in this limited area and to secure a predetermined weight, the vibration damping mechanism 170 needs to be precisely shaped.

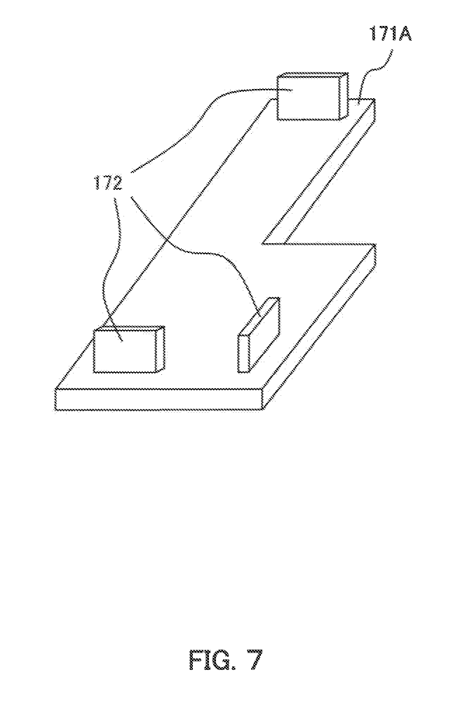

It is conceivable to make the weight 171 of a high specific-gravity metallic material by stamping process so as to increase its weight, but this scheme leads to the following manufacturing and cost problems: Firstly, as described above, the weight 171 needs to be located outside the printed circuit board 160 on the HDD 100, and the mounting space for the weight 171 is limited. A thickness of about a few millimeters is necessary to gain weight. A large thickness needs a large press machine, and increases the die cost and stamping cost. Secondly, the stamping process needs an unstamped end width, an unstamped interval in the feed direction, and an unstamped width for a pilot pin guide, each of which is 1 to 1.5 times as large as the thickness, making a material cost expensive due to the waste of the material. Thirdly, the brass material among the iron material, stainless steel and brass has the best workability and the largest specific gravity, providing the most effective function as a weight, but is most expensive in material cost and needs a corrosion-resistant surface treatment such as plating. On the other hand, the iron material has relatively better workability and is least expensive in material cost, but requires a corrosion-resistant surface treatment such as plating, and possesses a large difference of a coefficient of thermal expansion from that of aluminum, causing the housing 102 to thermally deform. Stainless steel needs no surface treatment, but is rather expensive in material cost and its shearing force is too large to stamp a thick material. In addition, stainless steel possesses a large difference of a coefficient of thermal expansion from that of aluminum, and causes the housing 102 to thermally deform. Fourthly, when the weight 171 is very thick or needs a three-dimensional shape for the mounting space convenience, the stamping process is difficult and the machining process becomes necessary, causing a waste of the material and increasing the manufacturing cost. The weight 171A having a three-dimensional shape as shown in FIG. 7 has some projections 172 engageable with recesses (not shown) in the housing 102 so as to increase the weight of the housing 102. Here, FIG. 7 is a schematic perspective view of the three-dimensional weight 171A at the rear side.

The vibration damping mechanism 170 of this embodiment has the weight 171 and a deformation reducer that reduces a deformation of the housing 102 caused by the weight 171. The deformation reducer has several embodiments:

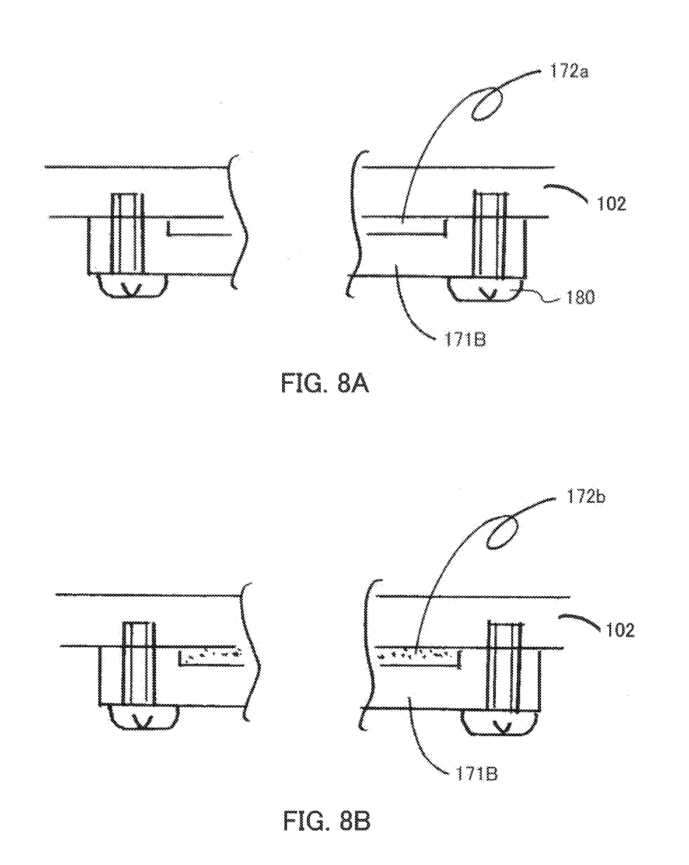

The deformation reducer of a first embodiment is implemented as a spacer part that thermally separates the weight 171 from the housing 102. When the weight 171 contacts the housing 102, the heat transfer occurs in the contact area and the housing 102 deforms due to a difference of a coefficient of thermal expansion between them. Accordingly, this embodiment reduces the deformation by reducing the thermal transfer area between the weight 171 and the housing 102. FIGS. 8A and 8B are schematic, partially sectional views showing an illustration that implements the deformation reducer as a thermal resistor. FIG. 5A forms a recess in a surface opposite to the housing 102 of the weight 1715, and the spacer part is implemented as an air gap or cavity 172a. FIG. 8B forms a recess in the surface opposite to the housing 102 of the weight 171B, and the spacer part is implemented as a thermal insulator 172b that is filled in the air gap or cavity 172a. The spacer part is formed on the weight 171B in this embodiment, and it may be formed on the housing 102. A size or volume of the recess is determined based on a required weight for the weight 171B and a necessary level of the thermal resistance.

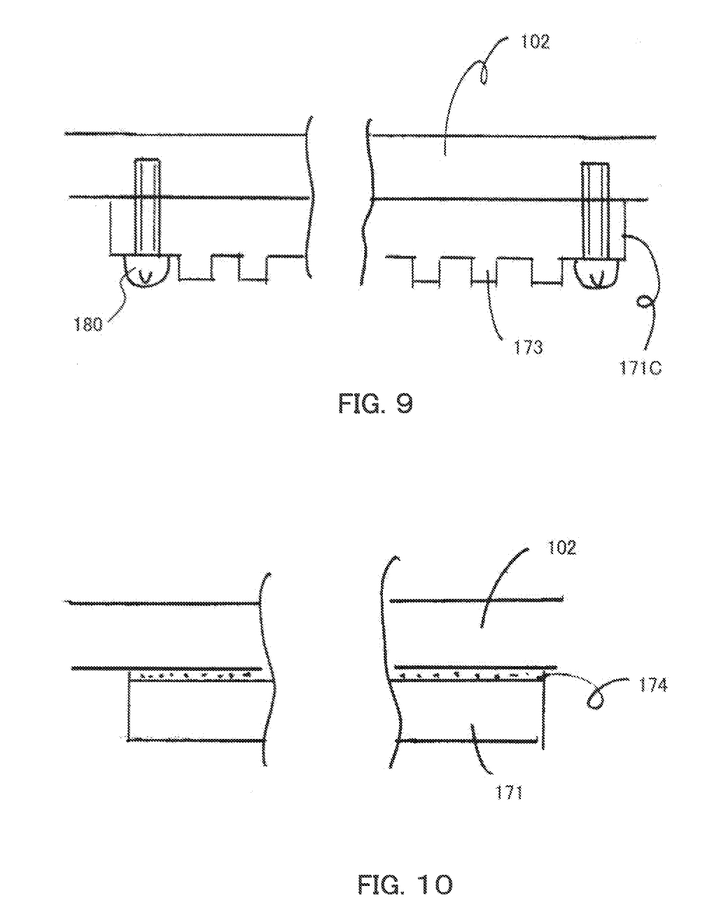

The deformation reducer of a second embodiment is implemented as a heat radiator that enhances the heat radiation from the weight 171. This structure reduces temperature changes of the weight 171 through the heat radiation, and diminishes deformations caused by the difference of a coefficient of thermal expansion. FIG. 9 is a schematic, partially sectional view of an illustration that implements the deformation reducer as a heat radiator. FIG. 9 implements the heat radiator as fins 173 each having a convexoconcave section formed on the surface of the weight 171C. The fin 173 increases its surface area by its convexoconcave shape, and enhances the heat radiation effect. The fins 173 of this embodiment are platy and extend in the same direction, but its shape is not limited, such as a quadrangular prism and a needle shape, as long as it increases the surface area. A area, height, and shape of the fin 173 are determined based on a required weight for the weight 171C and a necessary level of the heat radiation effect.

The deformation reducer of a third embodiment is implemented as an elastic adhesive layer 174 provided between the housing 102 and the weight 171 so that the deformation of the weight 171 does not influence the housing 102. This structure enables the elastic adhesive layer 174 to absorb deformations of the weight 171 and reduce the deformation of the housing 102, FIG. 10 is a schematic, partially sectional view of an illustration that implements the deformation reducer as the elastic adhesive layer 174. The elastic adhesive layer 174 made of a viscoelastic material is expected to effectively attenuate the vibration energy. The elastic adhesive layer 174 may be made, for example, acrylic resin or epoxy resin.

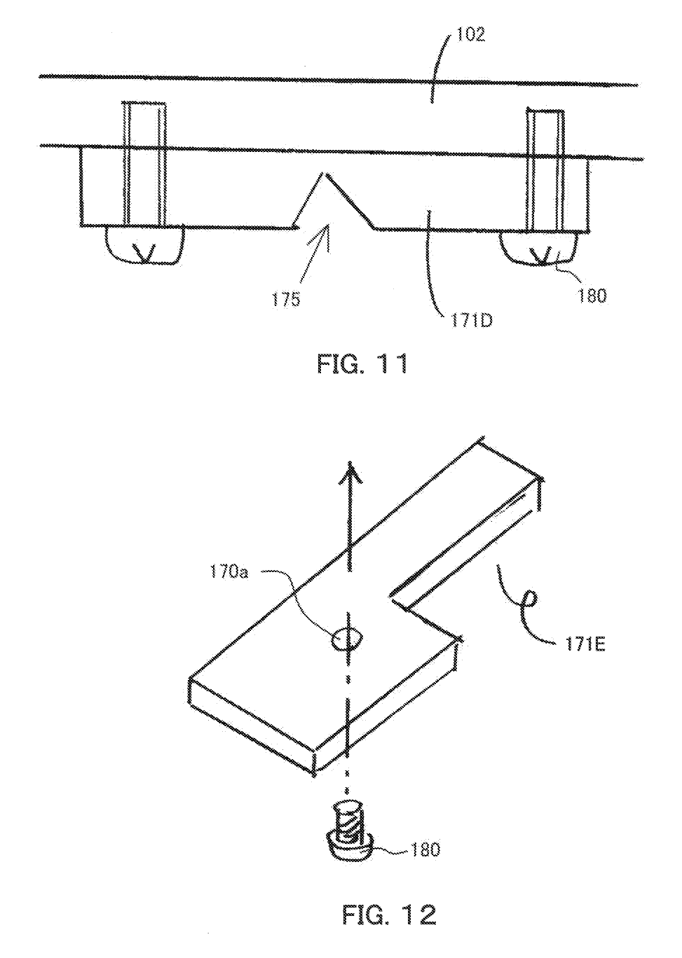

The deformation reducer of a fourth embodiment is implemented as a cut part 175 formed in the weight 171D. This structure makes the weight 171 flexible, and reduces its deformation that affects the deformation of the housing 102. FIG. 11 is a schematic, partially sectional view of an illustration that implements the deformation reducer as the cut part 175. A size and shape of the cut part 175, and the number of cut parts 175 are determined based on a required weight of the weight 171D and a necessary flexibility.

The deformation reducer of a fifth embodiment is implemented as a fixture member that fixes the weight 171E at one spot. FIGS. 4 and 5 screw the weights 171 at two spots. Please note that the reference numeral 171a shown in FIG. 5 denotes a screw hole. A deformation of the weight 171 between the two screws 180 affects the housing 102 via the screw 180. On the other hand, as shown in FIG. 12, when the, weight 171E is fixed by one screw 180 at one spot, no restraints prevent a deformation of the weight 171 from affecting the housing 102, reducing the deformation of the housing 102. Here, FIG. 12 is a schematic, perspective view of an illustration that implements the deformation reducer as a fixture member that fixes the weight 171E at one spot (utilizing the screw hole 171a and the screw 180).

The vibration damping mechanism 170 having the above deformation reducer can reduce the cost even when it uses the iron material and the stainless steel material instead of brass because the deformation reducer reduces the housing 102's deformation that would be otherwise caused by the difference of a coefficient of thermal expansion.

Another conceivable cost reduction method would save material usage and facilitate manufacturability, and a refrainment of stamping process is preferable for these purposes.

Accordingly, this embodiment makes the weight of resin to which a metal additive, such as tungsten, stainless steel, iron, and titan, is added. The content of resin is determined based on a necessary weight, and adjustable in a specific gravity range between 2 and 11. Resin can provide a precise shape, and utilize injection molding process that facilitates manufacturability. Once a molding die is produced, the manufacture is easy.

Use of a high specific-gravity resin material will provide the following effects: Firstly, the specific gravity is adjustable by adjusting an amount of the metal additive to resin, and thereby the vibration characteristic of the housing 102 can be adjusted. Secondly, use of a specific gravity material higher than iron and brass can reduce the weight size. Thirdly; use of injection molding can expand the possibility of a shape and fill resin in an otherwise dead space of the housing. Therefore, the three-dimensional shape shown in FIG. 7 can be made easily. Fourthly, resin does not require a corrosion-resistant surface treatment. Fifthly, injection molding process does not produce a large amount of scrap unlike stamping process and machining process, reducing a waste of materials and promoting the ecology.

The high specific-gravity resin material is available, for example, in Japanese Patent Application, Publication No. 9-320059 and as Product Name Thermocomp HSG (LNG engineering plastics, Japan GE plastics).

A sinter material and a metal injection molding material can provide similar effects as well as resin. Metal injection molding is available, for example, in Japanese Patent Application, Publication No. 7-252506 and as Product Name Cobalt (Hitachi Metals). Sinter material is available, for example, in Japanese Patent Applications, Publication Nos. 2001346924 and 2003-216141 and as Product Name Heavy Alloy (Nippon Tungsten Co., Ltd.).

Moreover, this embodiment makes the weight of high specific-gravity molten metal cast by die casting or lost wax casting process. Use of die casting or lost-wax casting provides the following effects: Firstly, casting, such as die casting or lost-wax casting, can utilize comparatively inexpensive iron, zinc alloy (with a specific gravity of 6.60), stainless steel, and brass. Secondly, use of casting will expand the possibility of a shape, and fill a material in the otherwise dead space in the housing. Therefore, the three-dimensional shape shown in FIG. 7 can be made easily. Thirdly, casting process does not produce a large amount of scrap metal unlike stamping process and metal machining process, reducing a waste of materials and promoting the ecology.

In operation of the HDD 100, the controller 161 drives the spindle motor 106 and rotates the disc 104. The airflow generated with the rotation of the disc 104 is introduced between the disc 104 and slider 121, forming a fine air film and thus generating the lifting force that enables the slider 121 to float over the disc surface. The suspension 130 applies an elastic bias force to the slider 121 in a direction against the lifting force of the slider 121. The balance between the lifting force and the elastic bias force spaces the magnetic head part 120 from the disc 104 by a constant distance. As discussed above, the vibration damping mechanism 170 reduces vibrations and noises of the housing 102, and the deformation reducer reduces deformations of the housing 1021 caused by a difference of a coefficient of thermal expansion between the housing 102 and the weight 171. Therefore, high-accurate positioning of the head 122 is implemented.

The controller 161 then controls the carriage 140 and swings the carriage 140 around the shaft 142 for head 122's seek for a target track on the disc 104. While this embodiment thus uses a swing, arm type in which the slider 121 draws an arc locus around the shaft 142, the present invention is applicable to a linear type in which the slider 121 draws a linear locus.

In writing, the controller 161 receives data from the host (not shown) such as a PC through the interface 162, selects the inductive head device, and sends data to the write modulator 164 through the HDC 163. In response, the write modulator 164 modulates the data, and sends the modulated data to the head IC 167. The head IC 167 amplifies the modulated data, and then supplies the data as write current to the inductive head device. Thereby, the inductive head device writes the data down in the target track.

In reading, the controller 161 selects the MR head device, and sends the predetermined sense current to the sense-current controller 166 through the HDC 163. In response, the sense-current controller 166 supplies the sense current to the MR head device through the head IC 167. Thereby, the MR head reads desired information from the desired track on the disc 104

Further, the present invention is not limited to these preferred embodiments, and various modifications and variations may be made without departing from the spirit and scope of the present invention. For example, while the above embodiments discuss the HDD, the present invention is applicable to other types of magnetic disc drives, such as a photo-magnetic disc drive.

1. A magnetic disc drive comprising:
a head that is configured to record information in a recording medium or reproduce the information from the recording medium;
a housing that houses the recording medium and the head; and
a vibration damping mechanism that reduces a vibration of the housing, and includes a weight attached to said housing and a deformation reducer that reduces a deformation of said housing caused by the weight.

2. A magnetic disc drive according to claim 1, wherein the deformation reducer is a spacer part that is located between the weight and the housing, and reduces an area in which the weight thermally contacts said housing.

3. A magnetic disc drive according to claim 2, wherein the spacer part has an air gap or thermal insulator provided between said housing and the weight.

4. A magnetic disc drive according to claim 1, wherein the deformation reducer is a heat radiator that enhances a heat radiation of the weight.

5. A magnetic disc drive according to claim 4, wherein the heat radiator is a convexoconcave part formed on a surface of the weight.

6. A magnetic disc drive according to claim 1, wherein the deformation reducer is elastic adhesive layer provided between said housing and the weight.

7. A magnetic disc drive according to claim 1, wherein the deformation reducer is a cut part formed in the weight.

8. A magnetic disc drive according to claim 1, wherein the deformation reducer is a fixture member that fixes the weight onto the housing at one spot.

9. A magnetic disc drive comprising:
a head that is configured to record information in a recording medium or reproduce the information from the recording medium;
a housing that houses the recording medium and the head; and
a vibration damping mechanism that reduces a vibration of the housing, and includes a weight attached to said housing, the weight being made of at least one of resin, a sinter material, and a metal injection molding material containing metal additive.

10. A magnetic disc drive comprising:
a head that is configured to record information in a recording medium or reproduce the information from the recording medium;
a housing that houses the recording medium and the head; and
a vibration damping mechanism that reduces a vibration of the housing, and includes a weight attached to said housing, the weight being made through die casting or lost-wax casting process that casts a high specific-gravity molten metal.
